(19) United States
(12) Patent Application Publication
(10) Pub. No.: US 2002/0011015 A1
(43) Pub. Date: Jan. 31, 2002

(54) Banner caps and system of use

(76) Inventors: Reed Larson, Palatine, IL (US); Mark Hughes, Chicago, IL (US)

Correspondence Address: JOSEPH M BARICH, MCANDREWS HELD & MALLOY LTD, 500 W MADISON STREET SUITE 3400, CHICAGO, IL, 60661, US

(21) Appl. No.: 09/849,112

(22) Filed: May 4, 2001

Related U.S. Application Data
(60) Provisional application No. 60/201,995, filed on May 4, 2000.

(51) Int. Cl. G09F 17/00

(52) U.S. Cl. 40/604; 40/603

(57) ABSTRACT

A banner display system including a system and method for the improved display of banners and other advertisements is provided. The banner display system includes a top banner cap, a bottom banner cap, and a banner wherein said banner includes a top sock for receiving a dowel and a bottom sock for receiving a dowel, said top sock resting against said top banner cap end stops and said bottom sock resting against said bottom banner cap end stops. The present invention provides stability and proper display for the banner as well as easy replacebility.

### BACKGROUND OF THE INVENTION

The present invention generally relates to a system and method for the improved display of banners and other advertisements. More particularly, the present invention relates to banner caps for the top and bottom of display banners to provide stability and proper display for the banner as well as easy replacebility.

Banners are often used as an advertising medium both indoors and outside. A typical example is an advertisement banner hung from the interior of the roof of a department store. The banner may be suspended above the heads of the shoppers so as to be easily readable from a considerable distance away. Banners may be made of virtually any substance, although typically banners are made from fabrics or paper stock of varying thicknesses.

Some of the banner display systems in use today offer the feature that the banner display system is reusable. That is, banner displayed may be replaced with another banner without discarding the banner display system. The banner is typically affixed in the banner display system through the use of a clamp or other compressive element at the top of the banner. The clamp is usually affixed to horizontal support that typically runs the length of the banner. The horizontal support is typically attached to and suspends from the interior of the roof of the department store. The bottom of the banner if typically merely suspends downward from the horizontal support.

In practice, the present banner display systems have several serious drawbacks. For example, because banners are typically suspended from interior ceilings, the banners are succeptible to air currents generated by the HVAC or other air circulation systems. The air currents may cause the banner to move laterally or horizontally, shake, twist, or otherwise become difficult to read, distracting, or otherwise unappealing. Thus, a banner display system that better displays the banner readably, even under the influence of air currents or other disturbances, would be highly desirable.

Additionally, many banner display systems may fail, especially those banner display systems that are influenced by air currents. For example, the typical clamp-based system may include a fabric banner. The fabric banner may be blown by the air current generated by an HVAC system, much as a sail on a ship. If the force exerted by the air current on the banner exceeds the strength of the clamp, the clamp fails and the banner is released. Inadvertent failure of a banner display system may be a cause for alarm for nearby shoppers and a potential liability hazard for store owners. Thus, a banner display system that provides for more reliable way to secure a banner to a display would be highly desirable.

Thus, a need has long been felt for an improved banner display system that provides for improved banner display. Additionally, a need has long been felt for a banner display system that provides for a more secure affixment of the banner to the display system.

### SUMMARY OF THE INVENTION

The present invention provides a banner display system a top banner cap, a bottom banner cap, and a banner wherein said banner includes a top sock for receiving a dowel and a bottom sock for receiving a dowel, said top sock resting against said top banner cap end stops and said bottom sock resting against said bottom banner cap end stops. The present invention provides stability and proper display for the banner as well as easy replacebility.

These and other features of the present invention are discussed or apparent in the following detailed description of the preferred embodiments of the invention.

### BRIEF DESCRIPTION OF THE DRAWINGS

FIG. 1 illustrates a banner caps banner display system according to a preferred embodiment of the present invention.

FIG. 2 illustrates a cut-away side view of the display system of FIG. 1 including the bottom banner cap, the banner, the top banner cap, and support wires.

FIG. 3 illustrates the top banner cap of the display system according to a preferred embodiment.

FIG. 4 illustrates the operation of the display system according to a first embodiment of the present invention.

FIG. 5 illustrates the operation of the display system according to a second embodiment of the present invention.

FIG. 6 illustrates a freestanding banner cap system according to a preferred embodiment of the present invention.

FIG. 7 further illustrates the freestanding banner cap system.

### DETAILED DESCRIPTION OF THE PREFERRED EMBODIMENTS

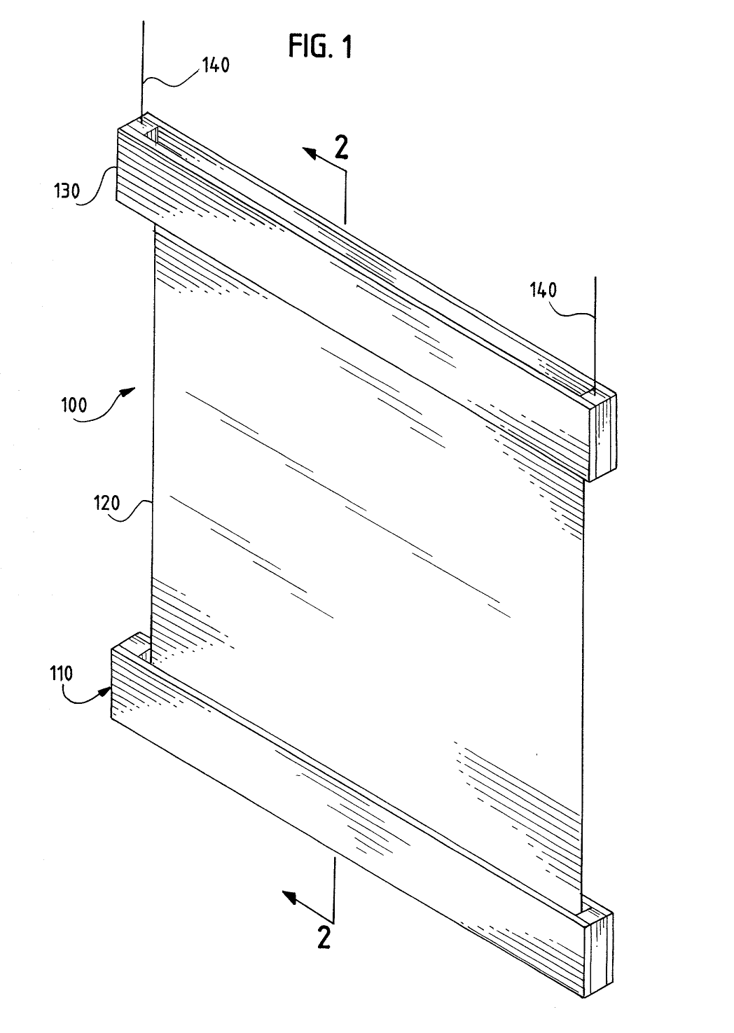

FIG. 1 illustrates a banner caps banner display system 100 according to a preferred embodiment of the present invention. The banner display system 100 includes a bottom banner cap 110, a banner 120, a top banner cap 130 and two support wires 140. The display system 100 of FIG. 1 is illustrated as a vertically-oriented system, but may be oriented in different ways, such as horizontally or diagonally oriented, for example. Additionally, the banner 120 is discussed below with reference to a cloth banner, but may be any of a variety of materials such as paper, fabric, or card stock, for example. Additionally, the banner display system 100 is presented as hanging from a surface, such as the interior ceiling of a store, for example. However, the top banner cap 130 may be suspended in any of a variety of ways, including directly affixing the top banner cap to a surface. Additionally, the display system 100 is presented with the bottom banner cap 110, top banner cap 130 and other elements as being made out of wood. However, the banner caps and other elements may be metal, plastic, or other rigid material.

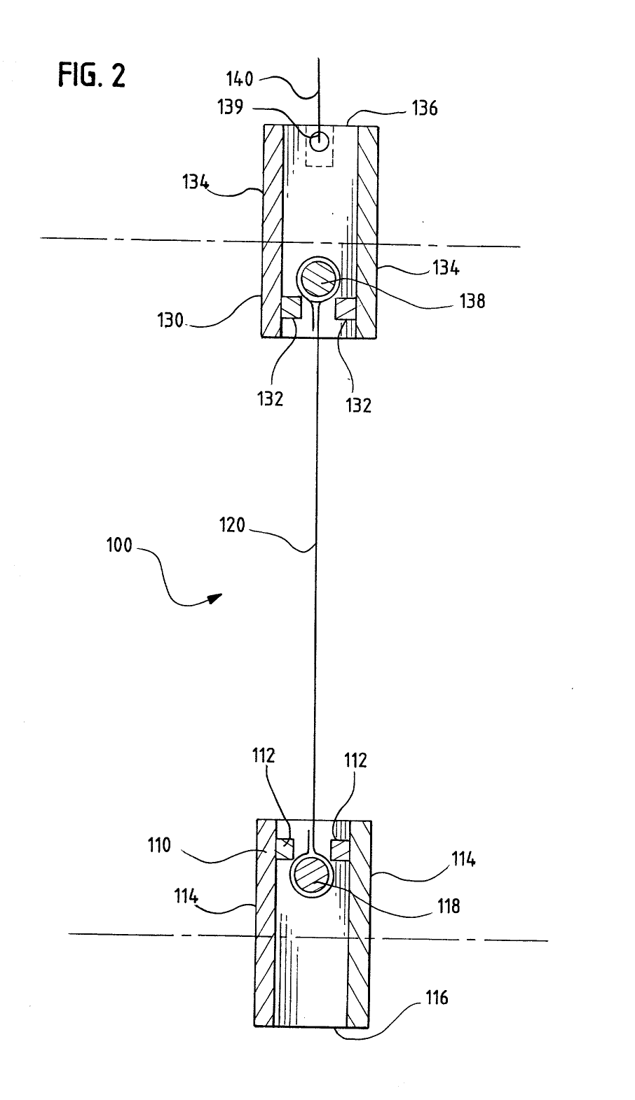

FIG. 2 illustrates a cut-away side view of the display system 100 of FIG. 1 including the bottom banner cap 110, the banner 120, the top banner cap 130, and support wires 140. The bottom banner cap 110 includes end stops 112, side panels 114, a banner insert aperture 116 and a dowel 118. The top banner cap 130 includes end stops 132, side panels 134, a banner insert aperture 136, a dowel 138, and a hanging fixtures 139.

In operation, the support wires 140 are attached to the hanging fixtures 139. The hanging fixtures may be eye hooks, for example. The support wires are used to attach the top banner cap 130 to the ceiling.

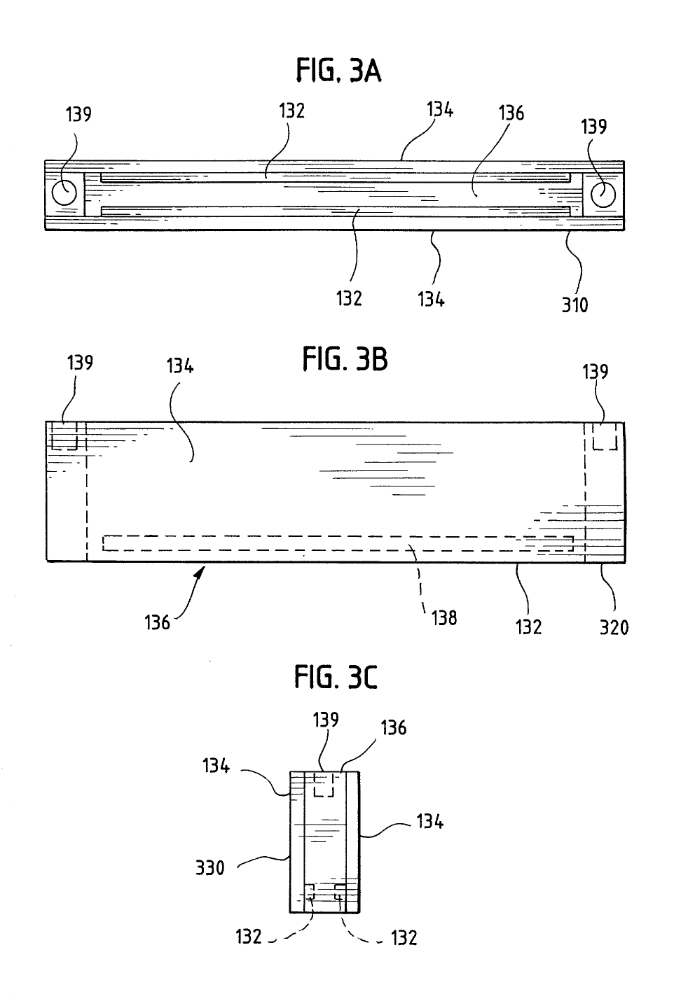

FIG. 3 illustrates the top banner cap 130 of the display system 100 according to a preferred embodiment. FIG. 3 includes a top view 310 of the top banner cap 130 illustrating the end stops 132, the side panels 134, the banner insert aperture 136, and the hanging fixtures 139. FIG. 3 also includes a front cut-away view 320 of the top banner cap 130 illustrating the end stops 132, the side panels 134, the banner insert aperture 136, the dowel 138, and the hanging fixtures 139. FIG. 3 also includes a side cut-away view 330 of the top banner cap 130 illustrating the end stops 132, the side panels 134, the banner insert aperture 136, and the hanging fixtures 139.

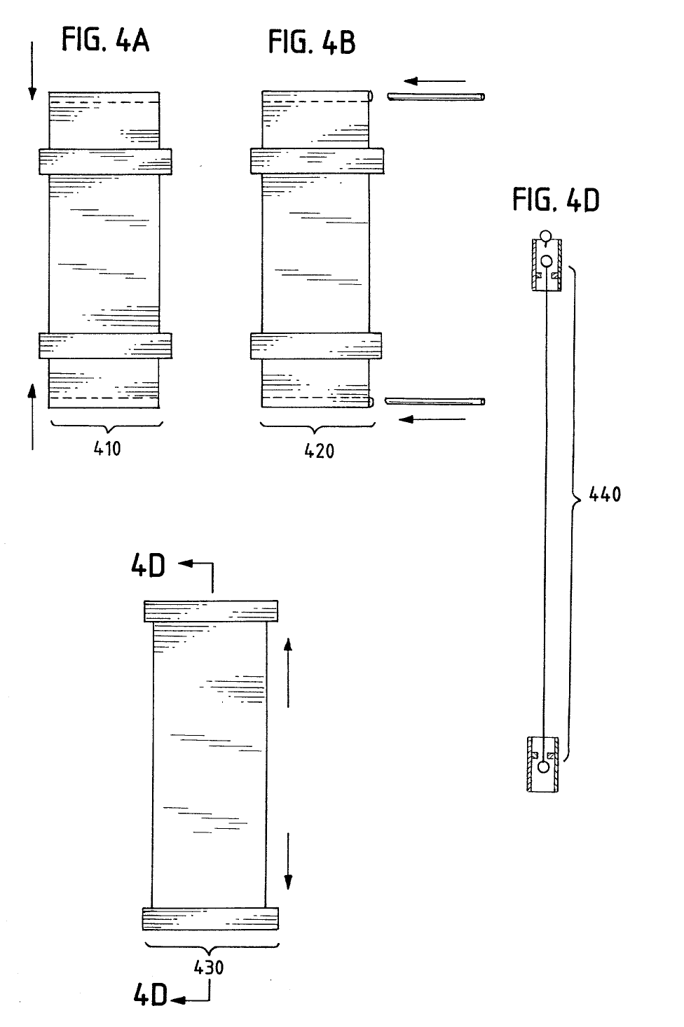

FIG. 4 illustrates the operation of the display system 100 according to a first embodiment of the present invention. In operation, the banner is first pre-prepared by the vender supplying the prints. That is, flexible stock includes socks to receive a dowel, and rigid stock includes either socks to receive a dowel or is hole punched to receive stops.

Next, the substrate or graphic, or banner to be displayed is laid on a flat surface as shown at 410. The graphic is positioned with regard to the bottom banner cap 110 and top banner cap 130 as shown so that the graphic slides through the banner insert apertures in the center of the banner caps 110, 130.

Then, the dowels 118, 138 are inserted into the socks of the graphic as shown at 420.

Next, the banner caps are slid to the ends of the graphic so that the dowels 118, 138 are seated against the end stops 112, 132 as shown at 430.

The banner display system is now ready to be suspended from the hanging fixtures 139 attached to the top banner cap 130 as shown at 440.

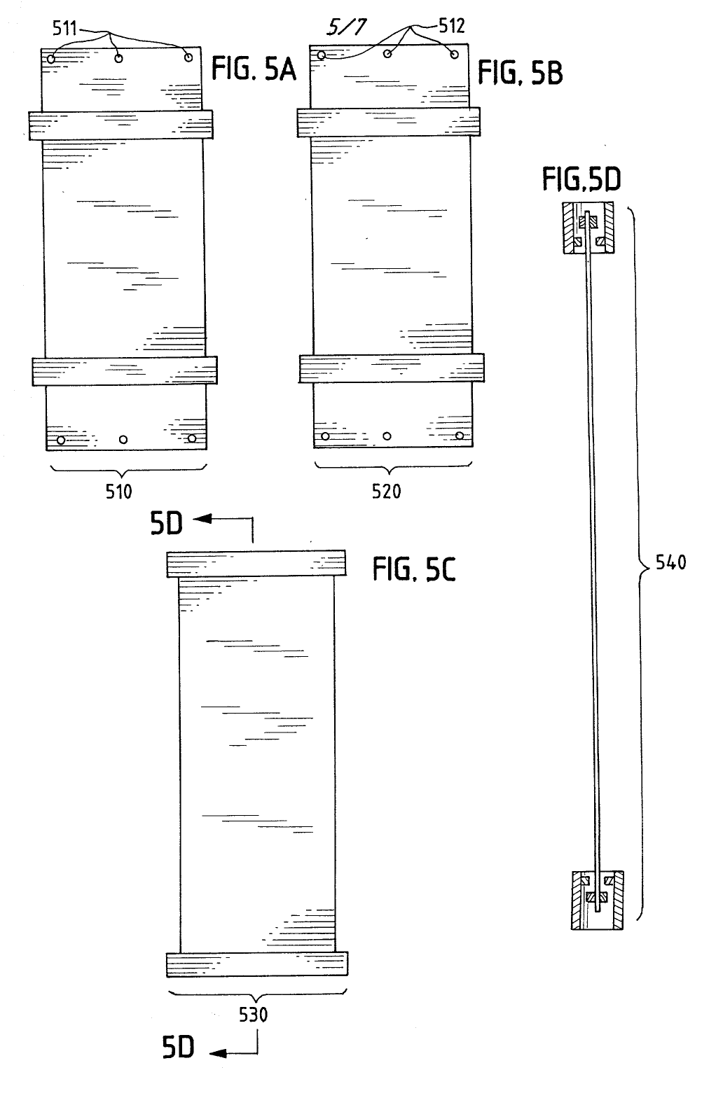

FIG. 5 illustrates he operation of the display system 100 according to a second embodiment of the present invention. That is, the banner to be displayed is rigid stock instead of flexible stock. In the second embodiment, the rigid stock is hole punched to receive stops.

Similar to FIG. 4 above, the graphic stock to be displayed is laid on a flat surface as shown at 510. The graphic is positioned with regard to the bottom banner cap 110 and top banner cap 130 as shown so that the graphic slides through the banner insert apertures in the center of the banner caps 110, 130. The graphic includes dowel stop holes 511 to receive short, cylindrical dowel stops.

Then, the short, cylindrical dowel stops 512 are inserted into the dowel stop holes 511 as shown at 520.

Next, the banner caps are slid to the ends of the graphic so that the dowels stops 512 are seated against the end stops 112, 132 as shown at 530.

The banner display system is now ready to be suspended from the hanging fixtures 139 attached to the top banner cap 130 as shown at 540.

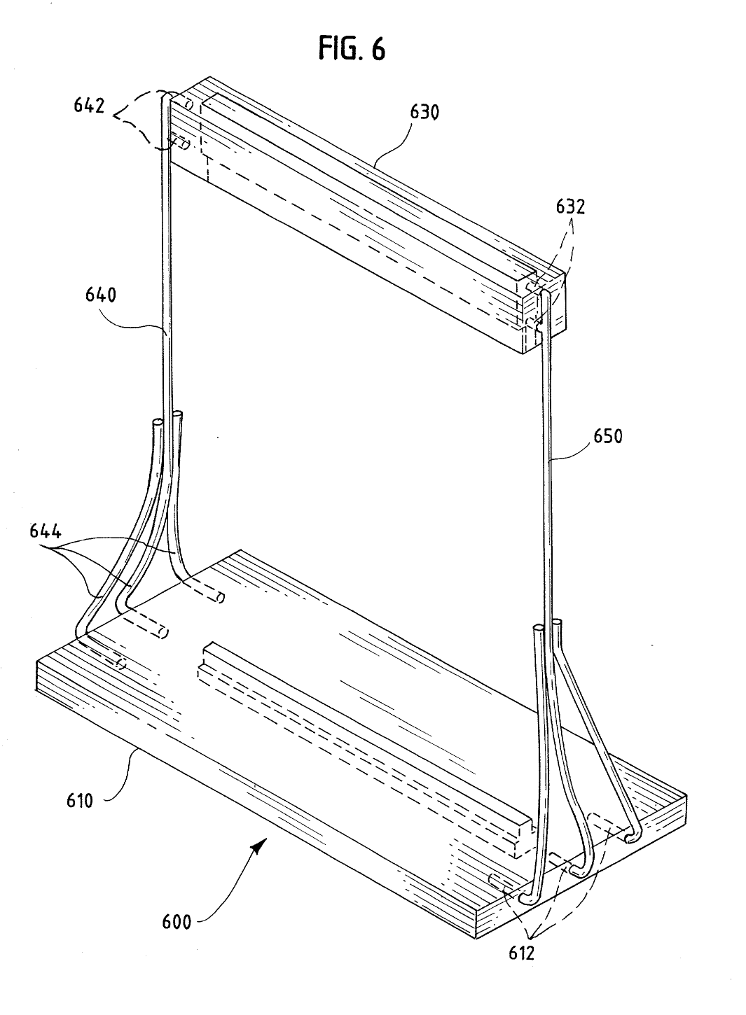

FIG. 6 illustrates a freestanding banner cap system 600 according to a preferred embodiment of the present invention. The freestanding system 600 includes a bottom banner cap 610, a top banner cap 630, and two side elements 640. The top banner cap and bottom banner cap 630, 610 are preferably made of wood and are substantially similar to the top banner cap and bottom banner cap 130, 110 of the embodiments discussed above. That is, both the top banner cap and bottom banner cap 630, 310 include end stops, side panels, banner insert apertures and apertures as discussed above. Additionally, the freestanding banner cap system 600 may be employed with flexible stock secured by a dowel or with rigid stock secured by dowel stops as discussed above.

The freestanding banner cap system 600 differs from the embodiments discussed above because the freestanding banner cap system 600 is mean to be a freestanding floor or counter model rather then a hanging model. Thus, the top banner cap 630 of the freestanding banner cap system 600 does not include hanging fixtures and instead includes side apertures 632. The side apertures 632 are typically drilled holes and the side apertures receive the upper fixturing arms 642 of the side elements 640.

The bottom banner cap 610 of the freestanding banner cap system 600 differs from the bottom banner cap 110 above because the bottom banner cap of freestanding banner cap system 600 has been extended horizontally to provide a secure base to the freestanding banner cap system 600. Additionally, the bottom banner cap 610 includes side apertures 612. The side apertures 612 are typically drilled holes and the side apertures 612 of the bottom banner cap 610 receive the lower fixturing arms 644 of the side elements 640.

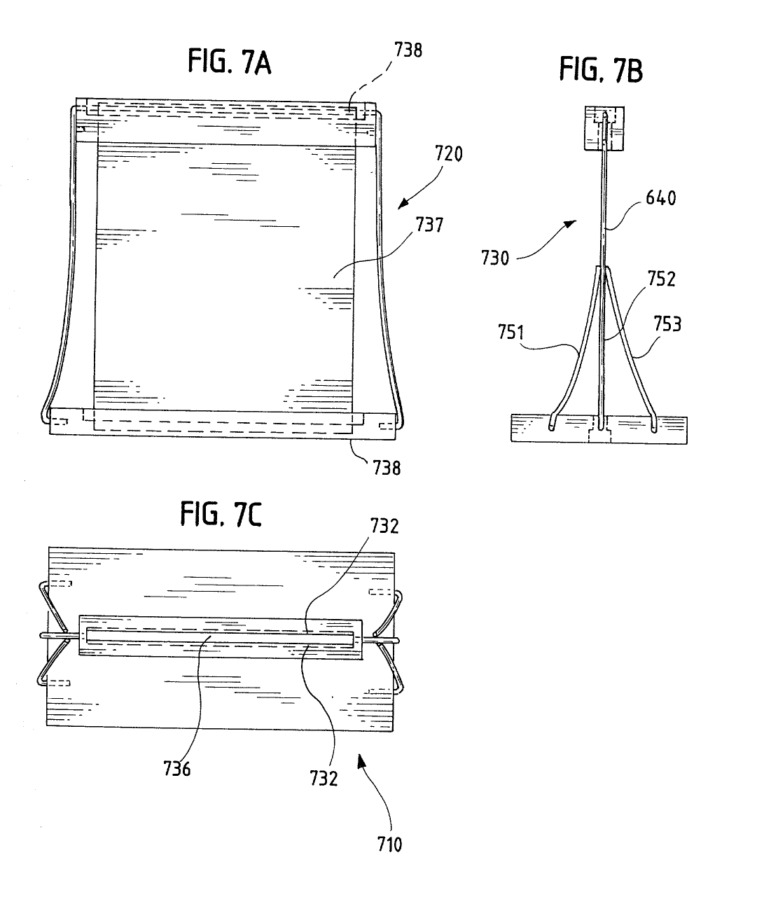

FIG. 7 further illustrates the freestanding banner cap system 600. FIG. 7 includes a top view 710, a front view 720, and an end view 730 of the freestanding banner cap system 600. As most easily seen in the top view 710, the freestanding banner cap system 600 includes end stops 732, side panels 734, a banner insert aperture 736, similar to the embodiments above. As most easily seen in the front view 720, the freestanding banner cap system 600 includes two dowels 738 and a suspended banner 737. As most easily seen in the end view 730, the side elements 640 preferably include a plurality of spines 751-753. The spines 751-753 provide for stability of the side elements 640 as they support the top banner cap 630.

Referring again to FIG. 6, in operation, the freestanding banner cap system 600 performs similarly to the embodiment of FIG. 4 above. That is, the banner is first pre-prepared by the vender supplying the prints. That is, flexible stock includes socks to receive a dowel, and rigid stock includes either socks to receive a dowel or is hole punched to receive stops.

Next, the substrate or graphic, or banner to be displayed is laid on a flat surface similar to that shown at 410. The graphic is positioned with regard to the bottom banner cap 610 and top banner cap 630 so that the graphic slides through the banner insert apertures in the center of the banner caps. Then, the dowels are inserted into the socks of the graphic similar to that shown at 420. Next, the banner caps are slid to the ends of the graphic so that the dowels are seated against the end stops similar to that shown at 430.

Next, the side elements 640 are positioned with regard to the top and bottom banner caps 630, 610. That is, the upper fixturing arms 642 of the side elements 640 are inserted into the side apertures 632 of the top banner cap 630 and the lower fixturing arms 644 of the side elements 640 are inserted into the side apertures 612 of the bottom banner cap 610. The side elements 640 provide a vertical support for the top banner cap 630. Additionally, the side elements 640 are preferably designed to allow the fixturing arms 642, 644 to be firmly placed into the side apertures 632, 612, for example, to allow the freestanding banner cap system 600 to be easily transported as a single unit. Additionally, the side elements 640 are preferably designed so that a graphic being displayed is taught between the top and bottom banner caps 630, 610.

Thus, the preferred embodiments of the present invention provide an improved system for hanging and displaying graphic images. The present invention pertains to any industry, personal or home use to display graphics or visual images for marketing, display, informational or personal viewing. As mentioned above, the use of banner caps relates to the general use and display of graphics and or visuals be they, paper, fabric materials, board products or any media that will carry a visual message. The present invention minimizes problems experienced with other systems in the market. The present invention provides

A. Ease of usage

B. Self Contained Unit

C. Fast and efficient change out system

D. Use with various graphic and or visual carrying medias

E. Manufactured easily in several materials

F. Custom finishing

G. Provide an additional surface to carry logo's or message.

H. Units that need to be taken down to insert new visuals and must be lined exactly.

I. Hidden edges of graphic attachment in system.

Additionally, current systems require users to detach/lower/remove various attachment devices in order to insert new visuals. New visuals require staples, punches, attachment of strips, clips, taping of graphics together to reinstall, or additional hardware is required to support other possible graphic carrying media's in order to display, attach finishing elements and rehang. Typical systems only come in one style or finish. All current systems rely on additional hardware elements that are required to hold graphics in place and users are required to purchase elements to maintain the system.

Thus the need has existed for a versatile and flexible system for finishing, ease of change out, displaying, and avoid additional purchases to maintain the unit. The invention minimizes all the above-mentioned problems by simply sliding the graphic up, sliding out the support member, sliding in a new graphic, reinsert the support member without the need to realign, and provides additional flexibility for the user covering elements A through I. The present invention also is a self-contained unit without additional need to purchase additional hardware by using a simple support system element and gravity.

The system provides a solution for a quick and efficient change out of graphic media's. The method used is a simple system of two side slat with an end caps and two liner on the interior to support the stabilizing support using gravity to hold the graphics in place in a level position.

Once the system is hung, a need no longer exists to detach the hanging system when reinserting new graphic media's or to repurchase additional hardware to support the system as graphic media material change. When changing out the user simply slides the old graphic up, slide out the support, release the old graphic, slide up the new graphic, reinsert the support and let the graphic slide back in the hidden trough. The system also allows the user to determine the desired custom finish length or thickness and a vehicle to support additional message if desired.

In the present embodiment also is a fairly straightforward device used to hang and display various graphic media materials. The basic principle of the preferred embodiment will be maintained throughout alternative materials used in manufacturing or visual design element changes to make the unit attractive to various user markers.

The invention/system is for display of graphic visual images using a potential variety of possible materials for construction with two side elements of a wide choice of widths, heights or thicknesses, two inner support elements are attached to the edges with staples, nails, welding, glue and an end cap attached closing each end with nails/staples/glue. Method of assembly is dependent upon the materials used for construction, or can be routed out of a single piece of material. A simple dowel support system length wise or several short dowel pieces width wise are used to attach the graphics in place in a hidden trough and held in place with gravity. The custom finishing of the units can be determined by the individual user for personal cases.

Additionally, the display system may be used to hang graphic materials (Photographic, Vinyl, Cloth, Canvas banners & graphics with a pocket), foam or Hardboard images. The two sections of the display system make a set (top & bottom). Both top & bottom have a recessed area to hide fold, (top & bottom edge). A slot to insert graphic with a dowel rod (for pocket images) small dowel sections that insert into holes punched in board top & bottom for foam or hardboard to hold graphic in place.

Thus, the present display system is a good-looking devise with a unique, efficient & fast change out system to display graphic images. The ease of use/change out/allows flexibility for any length/versatile to various graphic media's/quality appearance & cost effective. Anyone who needs to hang a graphic image that needs to have an appealing appearance and is trouble free may make use of the present invention. The present banner caps may be produced in almost any length-depth/height of device and may vary dependent upon length or look desired. The banner caps are preferably constructed on a per order is custom basis for single/prototype or bulk production. Because each order is custom there is flexibility to produce for store chains that may have several design and different needs per location. The primary material used for constructions include wood (Special woods available: Oak, Cherry-request) or metal (Special request: Units of Metal or Metal & Wood combination). Additionally, the material may b Painted/Stained/or Lacquered-upon request, may include Logos or may include Etched/Silk Screened/Vinyls applied/Metal/Wood etc.

This new system allows in store retail people to change out graphics faster and with ease. The ability for the top and bottom of the banner to be hidden in a recessed area added an extra-added quality level to appearance. Because system can be produced in a variety of sizes it makes a flexible & user-friendly unit. With several options that allow the unit to be personalized for user special purposes.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features which come within the spirit and scope of the invention.

1. A banner display system including:
a top banner cap having top banner cap end stops;
a bottom banner cap having bottom banner cap end stops; and
a banner, wherein said banner includes a top sock for receiving a dowel and a bottom sock for receiving a dowel, said top sock resting against said top banner cap end stops and said bottom sock resting against said bottom banner cap end stops.
